(19) United States
(12) Patent Application Publication
(10) Pub. No.: US 2006/0067199 A1
(43) Pub. Date: Mar. 30, 2006

(54) Laser diode module multi-layer board and laser diode module

(75) Inventor: Hiroshi Tanaka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/206,129

(22) Filed: Aug. 18, 2005

(30) Foreign Application Priority Data
Aug. 24, 2004 (JP) 2004-244271
Aug. 24, 2004 (JP) 2004-244272

(51) Int. Cl. G11B 7/00

(52) U.S. Cl. 369/121

(57) ABSTRACT

A light emitting/receiving unit including a laser diode (LD) and a light receiving element, and an LD protection component for protecting the LD from electric damages are mounted on a multi-layer board for integration into a single module. A circuit for superposing a high-frequency current on an LD driving signal, and an anti-EMC circuit for reducing electromagnetic noise produced from this circuit may be included in the module, where at least some of elements making up these circuits may be incorporated into the board. In this structure, in order to reduce the distance between a coil and a capacitor included in the anti-EMC circuit, the capacitor is arranged within the board at a position substantially beneath the coil mounted on a surface of the board.

### BACKGROUND OF THE INVENTION

The present invention relates to a laser diode module multi-layer board and a laser diode module, and more particularly to a semiconductor laser diode module (hereinafter, the laser diode is simply abbreviated as “LD”) for use in an optical pickup in optical disc drive apparatuses such as DVD, CD, MO drives, and the structure of a board suitable for building the module thereon.

An optical disc drive apparatus, which uses an optical disc such as DVD, CD, MO or the like as a recording medium, comprises an optical pickup which contains a semiconductor LD that generates light irradiated to the disc for recording and reproducing information.

Such an optical pickup may comprise, as its components, LD protection components for protecting the LD from electric damages due to electrostatic discharge damage, surge current and the like; a high frequency superposing circuit for superposing a high frequency current on an LD driving current; and anti-EMC components for reducing electromagnetic noise produced from the high frequency superposing circuit, in addition to the foregoing LD. The optical pickup further comprises a flexible printed circuit board for mounting and interconnecting the foregoing components, optical components, a frame which serves as the skeleton of the optical pickup, metal plates for holding the shape, screws, and the like.

Optical pickup devices are disclosed, for example, by JP-A-2002-184013, JP-A-2000-138411, and JP-A-2001-014720.

### SUMMARY OF THE INVENTION

In recent years, like a variety of electronic devices, a reduction in size and thickness, higher performance, and a lower price have been strongly required for optical disc drive apparatuses, and particularly, such requirements are strict for portable type devices. However, the current situation is such that though respective components have been reduced in size year by year, conventional optical pickup structures encounter increasing difficulties in sufficiently satisfying these requirements.

To solve the foregoing difficulties, the inventors investigated the structure of the optical pickup with the intention of achieving a further reduction in size, thickness, and cost as well as higher performance of the optical pickup, and found improvements thereon.

Specifically, the conventional optical pickup has employed a structure in which a flexible printed circuit board is mounted with a generally packaged LD component (light emitting/receiving unit component including a semiconductor laser for generating light irradiated to a storage medium, and a light receiving element for receiving light reflected from the storage medium); LD protection components; and high frequency superposing circuit components and anti-EMC components, provided as required. Then, the flexible printed circuit board, together with these components, are incorporated into a frame in which optical components have been incorporated.

However, when respective components are individually mounted on the flexible printed circuit board which is then incorporated into the frame, the incorporation of the components into the frame tends to leave useless spaces within the frame, thus causing difficulties in a reduction in size. Also, in the conventional structure in which the respective components are incorporated on a one-by-one basis, it is difficult to reduce the length of a connection line between the LD and high frequency superposing circuit, thus causing an additional problem of susceptibility to unwanted radiations.

Further, the life cycle of electronic devices tends to be increasingly shorter so that a reduction is requested for a time period needed for the development and design of products, together with a reduction in size and enhanced performance. However, the conventional incorporation-type optical pickup structure involves long time and effort for design, adjustment, operation confirmation and the like of the LD and respective circuits (components), and is accordingly disadvantageous in regard to the cost.

The foregoing problems cannot be sufficiently solved by the inventions described in the aforementioned patent documents which disclose optical pickup devices.

It is therefore an object of the present invention to provide a high-performance optical pickup which further reduces the size, cost, and unwanted radiations.

To achieve the above object to solve the problems, a first LD (laser diode) module multi-layer board of the present invention includes a light emitting/receiving unit mounting area for mounting thereon a light emitting/receiving unit component including a semiconductor laser diode for generating light irradiated to a storage medium, and a light receiving element for receiving reflected light from the storage medium, and a laser diode protection component mounting area for mounting thereon a laser diode protection component for protecting the semiconductor laser diode from electric damages.

An optical pickup for recording/reproduced information to/from a storage medium such as DVD, CD, MO or the like is provided with a light emitting/receiving unit component (for example, a hologram laser diode) which includes an LD for generating light emitted to the recording medium, and a light receiving element for receiving light reflected from the storage medium.

The multi-layer board of the present invention includes the light emitting/receiving unit mounting area for mounting thereon the light emitting/receiving unit component, and the LD protection component mounting area for mounting an LD protection component for protecting the LD from electric damages. Here, the “electric damages” refer to electrostatic discharge damages (damages due to electrostatic discharge (ESD)) or damages due to a surge current and the like. Therefore, the LD and LD protection component can be integrally mounted on the board to provide an LD module which includes the LD protection component, thereby making it possible to reduce the size of the optical pickup as compared with before, and to simplify its designing and assembling steps.

The multi-layer board of the present invention can be, for example, a ceramic multi-layer board, a low-temperature co-fired ceramics (LTCC) multi-layer board made of alumina and glass components, or an organic multi-layer board which employs a resin material for an insulating base material. This organic multi-layer board includes a composite material board made of a mixture of a resin material and an inorganic material.

A second LD module multi-layer board of the present invention contains at least some of circuit elements of a high-frequency superposing circuit for superposing a high-frequency current on a current for driving the semiconductor laser diode, and at least some of circuit elements of an anti-EMC circuit (circuit for EMC (Electro Magnetic Compatibility)) for reducing electromagnetic noise produced from the high-frequency superposing circuit in the first LD module multi-layer board, and accordingly can further reduce the size of the optical pickup.

A third LD module multi-layer board of the present invention further includes a coil mounting area for mounting thereon a coil which forms part of the anti-EMC circuit, wherein the anti-EMC circuit includes a capacitor incorporated in the board, and the capacitor is arranged at a position substantially beneath the coil mounting area, in the second LD module multi-layer board.

In the optical pickup, the anti-EMC circuit for reducing electromagnetic noise produced from a high-frequency superposing circuit is provided by forming a filter, for example, of a coil and a capacitor, and inserting the filter between a terminal applied with an LD driving current and the high-frequency superposing circuit, wherein parasitic reactance increases as the coil and capacitor, making up the filter, are mounted spaced further apart from each other, resulting in a degradation in the filter characteristics.

On the contrary, according to the third board structure of the present invention, the coil and capacitor, which form the filter, can be mounted in close proximity to each other to reduce a wire between the coil and capacitor, thus making it possible to keep the parasitic reactance small, shift the resonance frequency of the filter to the higher side, and form a deeper notch. Consequently, the resulting LD module can provide high performance, and excels in EMC countermeasures.

A fourth LD module multi-layer board of the present invention further includes heat dissipating via hole (hereinafter called the “dissipation via”) extending through the laser diode module multi-layer bard and formed in an area in which the light emitting/receiving unit component is mounted, for dissipating heat produced from the semiconductor laser diode to the opposite surface side of the board to the board surface on which the light emitting/receiving unit mounting area is defined, in the first to third LD module multi-layer boards.

According to the fourth board structure as described above, by providing the dissipation via in the area in the light emitting/receiving unit mounting area, heat produced from the LD can be directly dissipated to the back of the board (through a minimum distance), to provide good heat dissipation capabilities of the LD module.

The heat dissipating via hole can be, for example, a plated throughhole filled with a thermally conductive material (for example, an electrically conductive resin paste). Also, when a higher heat dissipating capability should be ensured, the heat dissipating via hole is preferably implemented by a so-called filled via, which involves depositing a plating metal to fill in the throughhole to form the plating metal in a columnar shape, from a viewpoint of the heat dissipation efficiency.

A fifth LD module multi-layer board of the present invention further includes a connection pattern for a flexible printed circuit board, in the first to fourth LD module multi-layer board, wherein the light emitting/receiving unit mounting area is defined on one surface of the laser diode module multi-layer board, and the connection pattern for a flexible printed circuit board is defined on the other surface of the laser diode module multi-layer board.

When the light emitting/receiving unit mounting area is defined on one surface of the board, while the connection pattern for a flexible printed circuit board is disposed on the other surface, the surfaces of the board can be efficiently utilized, thereby reducing the board for forming the LD module to further reduce the size of the LD module. Also, the light emitting/receiving unit component is mounted on the board, for example, by wire bonding or the like, in which case, with the light emitting/receiving unit mounting area defined on one surface of the board, separately from the connection pattern for a flexible printed circuit board disposed on the other surface as mentioned above, a flexible printed circuit board can be connected to the LD module with the connecting operation performed only on the one surface on which the connection pattern is disposed. As such, since there is no need to touch the surface of the board on which the light emitting/receiving unit component is mounted, it is less likely to damage the light emitting/receiving unit component during the handling in the connection process, or to touch a bonding wire to cause an accidental disconnection, thus making it possible to increase the product yield rate.

In a sixth LD module multi-layer board of the present invention, the connection pattern for a flexible printed circuit board is formed in arrangement along an edge of the laser diode module multi-layer board, thereby facilitating the operation for connecting a flexible printed circuit board to the LD module multi-layer board.

Further, a seventh LD module multi-layer board of the present invention further includes a heat dissipating via hole extending through the laser diode module multi-layer board and formed in an area in which the light emitting/receiving unit component is mounted, for dissipating heat produced from the semiconductor laser diode to the opposite surface side of the board to the board surface on which the light emitting/receiving unit mounting area is defined, wherein the connection pattern for a flexible print board is disposed on both sides of the area in which the heat dissipation via hole is formed.

By thus arranging the connection pattern with respect to the heat dissipating via and flexible printed circuit board, the operation can be facilitated for connecting a flexible printed circuit board to the LD module multi-layer board, as is the case with the sixth board, while ensuring a good heat dissipating capability of the LD module. Also, the board can be reduced in size by arranging the connection pattern on both sides of the heat dissipating via.

An eighth LD module multi-layer board of the present invention further includes an active element mounting area for mounting thereon a semiconductor active element which forms part of a high-frequency superposing circuit for superposing a high-frequency current on a current for driving the semiconductor laser diode, wherein the light emitting/receiving unit mounting area is defined on one surface of the laser diode module multi-layer board, and the active element mounting area is defined on the other surface of the laser diode module multi-layer board.

Also, a ninth LD module multi-layer board of the present invention further includes a reference potential layer disposed between the light emitting/receiving unit mounting area and the active element mounting area in the eighth board.

Further, a tenth LD module multi-layer board of the present invention includes two or more of the reference potential layers.

When the LD and high-frequency superposing circuit are integrated in a module, concerns rise that the ID would be adversely affected by electromagnetic coupling with the high frequency superposing circuit, particularly, with the semiconductor active element included in an oscillator circuit within this circuit. On the other hand, in the eighth board structure of the present invention, the light emitting/receiving unit mounting area is defined on one surface of the LD module multi-layer board, while the active element mounting area is defined on the other surface, and further in the ninth board structure of the present invention, the reference potential layer is interposed between these light emitting/receiving unit mounting area (LD) and active element mounting area (semiconductor active element), thereby breaking such coupling to reduce or eliminate the influence on the LD. Also, for preventing the influence due to the coupling with higher certainty, two or more reference potential layers are preferably provided, as in the tenth board of the present invention.

In another aspect, a first laser diode module of the present invention includes a light emitting/receiving unit component including a semiconductor laser diode for generating light irradiated to a storage medium, and a light receiving element for receiving light reflected from the storage medium, and a laser diode protection component for protecting the semiconductor laser diode from electric damages, wherein the light emitting/receiving unit component and the laser diode protection component are integrated in a single module.

According to the module as described above, similar to the multi-layer board according to the present invention, it is possible to reduce the size of the optical pickup, as compared with before, and to facilitate its designing and assembling steps.

In a second laser diode module of the present invention, the semiconductor laser diode is a single-mode semiconductor laser diode in the first module, and the module further comprises a high-frequency superposing circuit integrated therein for superposing a high-frequency current on a current for driving the single-mode semiconductor laser diode.

The integration of the high frequency superposing circuit into the module can reduce the size of the optical pickup. In addition, an assembler/manufacturer need not individually design high-frequency superposing circuits optimal to a variety of LD's for use in a variety of products, or perform complicated adjusting operations and the like between the LD and high-frequency superposing circuit, thus making it possible to provide a highly convenient optical pickup component which is more user-friendly for the assembler/manufacturer.

The single-mode semiconductor LD has a number of advantages such as the ability to stably operate over a wide operating temperature range with low power consumption, high mass-productivity, reduction in cost of optical pickup, and the like, while it generally requires a high frequency superposing circuit for removing noise due to return light from the disc. On the other hand, a multi-mode (self-excited) LD, though not requiring the high-frequency superposing circuit, have disadvantages such as difficulties in mass production at a high yield rate, a narrower temperature range in which stable vibrations can be ensured than the single-mode LD, larger power consumption, larger amount of heat produced thereby, and lower reliability. Particularly, at a shorter wavelength, a resulting higher energy density (for example, for DVD associated with a shorter wavelength, or the like) causes an increase in the amount of produced heat, which makes a stable control difficult. Also, the requirement for a large-scaled heat dissipating structure makes it difficult to reduce the size.

Since the second module of the present invention employs the single-mode LD, and integrates the high-frequency superposing circuit suited to the LD into the module, this module can avoid the requirements of complicated designing, adjustments and the like individually performed for respective high frequency superposing circuits, while maintaining the respective advantageous characteristics exhibited by the single-mode LD, to provide the ease of handling comparable to the multi-mode LD during the development, designing, and manufacturing of the optical pickup.

A third laser diode module of the present invention further includes an anti-EMC circuit integrated therein for reducing electromagnetic noise produced from the high-frequency superposing circuit.

According to the third module as described above, the assembler/manufacturer of the optical pickup or optical disc drive apparatus can incorporate the module as it is to manufacture an optical pickup without the need for complicated circuit designing, adjustments and the like not only for the high-frequency superposing circuit but also for the anti-EMC circuit.

Though not specifically identified due to the fact that optimal elements or circuit configuration should be designed as appropriate in accordance with the type and characteristics of a particular LD intended for use (for example, the input impedance), the anti-EMC circuit is made up of, for example, passive elements such as an inductor (coil), a capacitor, a resistor and the like, or a combination of a plurality of these passive elements.

In a fourth LD module of the present invention, the light emitting/receiving unit component is mounted on a surface of a multi-layer board, and at least one of circuit elements making up one or both of the high frequency superposing circuit and the anti-EMC circuit are incorporated in the multi-layer board, thereby making it possible to further reduce the size of the optical pickup. The multi-layer board used to mount the light emitting/receiving unit component and LD protection component may be any of a variety of boards similar to the multi-layer board of the present invention described above.

In a fifth LD module according of the present invention, the anti-EMC circuit includes a coil and a capacitor, wherein the coil is mounted on a surface of the multi-layer board, and the capacitor is incorporated in the multi-layer board and arranged at a position substantially beneath the coil.

According to the module as described above, the coil and capacitor, which form the filter, are arranged in close proximity to each other, as is the case in the third multi-layer board according to the present invention, so that the resulting ID module exhibits high performance and excels in EMC countermeasures.

In a sixth LD module of the present invention, the laser diode module multi-layer board includes a heat dissipating via hole extending therethrough and formed in an area in which the light emitting/receiving unit component is mounted, in the fourth or fifth module, for dissipating heat produced from the semiconductor laser diode to the opposite surface side of the board to the board surface on which the light emitting/receiving unit is mounted.

Accordingly, the sixth module as described above can improve the heat dissipation capability of the LD module, like the fourth multi-layer board. The heat dissipation via can be a plated throughhole filled with a thermally conductive material (for example, an electrically conductive paste) or a filled via.

A seventh LD module of the present invention further includes a connection pattern for a flexible printed circuit board, wherein the light emitting/receiving unit component is mounted on one surface of the multi-layer board, and the connection pattern for a flexible printed circuit board is disposed on the other surface of the multi-layer board.

In an eighth LD module of the present invention, the connection pattern for a flexible printed circuit board is formed in arrangement along an edge of the multi-layer board, thereby making it possible to facilitate an operation for connecting a flexible printed circuit board to the LD module.

A ninth LD module of the present invention includes, in the eighth module, a heat dissipating via hole extending through the laser diode module multi-layer board and formed in an area in which the light emitting/receiving unit component is mounted, for dissipating heat produced from the semiconductor laser diode to the opposite surface side of the board to the board surface on which the light emitting/receiving unit is mounted, and the connection pattern for a flexible printed circuit board is arranged on both sides of the area in which the heat dissipation via hole is formed.

In a tenth LD module of the present invention, the semiconductor laser diode is a single-mode semiconductor laser diode, and the module further comprises a high-frequency superposing circuit integrated therein for superposing a high-frequency current on a current for driving the single-mode semiconductor laser diode, wherein the light emitting/receiving unit component is mounted on one surface of the multi-layer board, and a semiconductor active element included in the high-frequency superposing circuit is mounted on the other surface of the multi-layer board.

An eleventh LD module of the present invention further includes a reference potential layer disposed between the light emitting/receiving unit component and the semiconductor active element in the tenth module, and a twelfth LD module of the present invention includes two or more of the reference potential layers.

Accordingly, these modules can prevent the LD from being adversely affected by electromagnetic coupling with the semiconductor active element included in an oscillator circuit within the high-frequency superposing circuit, in a manner similar to the ninth and tenth boards of the present invention.

A thirteenth LD module of the present invention further includes, in any of the modules according to the present invention, an IC, integrated therein, capable of controlling a reproduced signal outputted from the light emitting/receiving unit component, or a reproduced signal and a recording signal outputted/inputted to/from the light emitting/receiving unit.

According to the thirteenth module, when the control IC is further mounted on the multi-layer board which has been mounted, for example, with the light emitting/receiving unit component, no connection is required between the light emitting/receiving unit component and control IC through the flexible printed circuit board or the like, so that the resulting optical pickup can be reduced in size, as is the case in the first to third modules.

In the thirteenth module, when a connection pattern is provided for a flexible printed circuit board, it is preferable that the light emitting/receiving unit component and control IC are mounted on one surface of the multi-layer board, while the connection pattern for a flexible printed circuit board is disposed on the other surface of the multi-layer board. This is intended to facilitate the operation for connecting the flexible printed circuit board and to prevent an accidental disconnection of a bonding wire of the control IC during a flexible printed circuit board connecting step, as is the case with the seventh module.

While the control IC electrically processes and controls a reproduced signal (when associated with a reproduction-only disc drive apparatus) or a reproduced signal and a recording signal (when associated with a disc drive apparatus capable of recording and reproducing signals), the control IC is not particularly limited in functions (specific circuits) included therein. For example, the control IC may include a high-frequency superposing circuit, a servo signal processing circuit for tracking, an A/D converter circuit, a D/A converter circuit, a signal amplifier circuit, and the like.

The multi-layer board and LD module according to the present invention can be utilized as an LD module for an optical pickup employed in optical disc drive apparatuses (including a combo-drive device which can record and reproduce onto and from a plurality of types of recording media, a DVD multi-drive device, and the like) which use a variety of optical discs as recording media, including DVD's (DVD-ROM, DVD-RAM, DVD-R, DVD-RW and the like), CD's (CD-ROM, CD-R, CD-RW and the like), MD (Mini Disc), MO (magneto-optical disc), optical video disc, optical PCM audio disc and the like, and as a board which forms part of the module.

According to the present invention, it is possible to provide a high-performance optical pickup which is smaller in size and manufactured at a lower cost, as well as reduces unwanted radiations. The other objects, features, and advantages of the present invention will become apparent from the following description of embodiments of the present invention, which is made with reference to the accompanying drawings in which the same reference numerals designate the same or corresponding parts.

### BRIEF DESCRIPTION OF THE DRAWINGS

FIG. 1 is a block diagram illustrating an LD module according to a first embodiment of the present invention;

FIG. 2 is a circuit diagram illustrating the LD module according to the first embodiment;

FIG. 3 is a plan view illustrating the LD module according to the first embodiment;

FIG. 4 is a side view illustrating the LD module according to the first embodiment;

FIG. 5 is a bottom view illustrating the LD module according to the first embodiment;

FIGS. 6A to 6T are perspective views illustrating a first layer to a twentieth layer of a multi-layer board which forms the LD module of the first embodiment, respectively;

FIG. 7 is a block diagram illustrating an LD module according to a second embodiment of the present invention;

FIG. 8 is a circuit diagram illustrating the LD module according to the second embodiment;

FIG. 9 is a plan view illustrating the LD module according to the second embodiment;

FIG. 10 is a side view illustrating the LD module according to the second embodiment;

FIG. 11 is a bottom view illustrating the LD module according to the second embodiment;

FIG. 12 is a plan view of an LD module according to a third embodiment of the present invention;

FIG. 13 is a side view illustrating the LD module according to the third embodiment;

FIG. 14 is a bottom view illustrating the LD module according to the third embodiment;

FIG. 15 is a block diagram illustrating an LD module according to a fourth embodiment of the present invention;

FIG. 16 is a plan view illustrating the LD module according to the fourth embodiment;

FIG. 17 is a side view illustrating the LD module according to the fourth embodiment; and

FIG. 18 is a bottom view illustrating the LD module according to the fourth embodiment.

### DESCRIPTION OF THE EMBODIMENTS

### First Embodiment

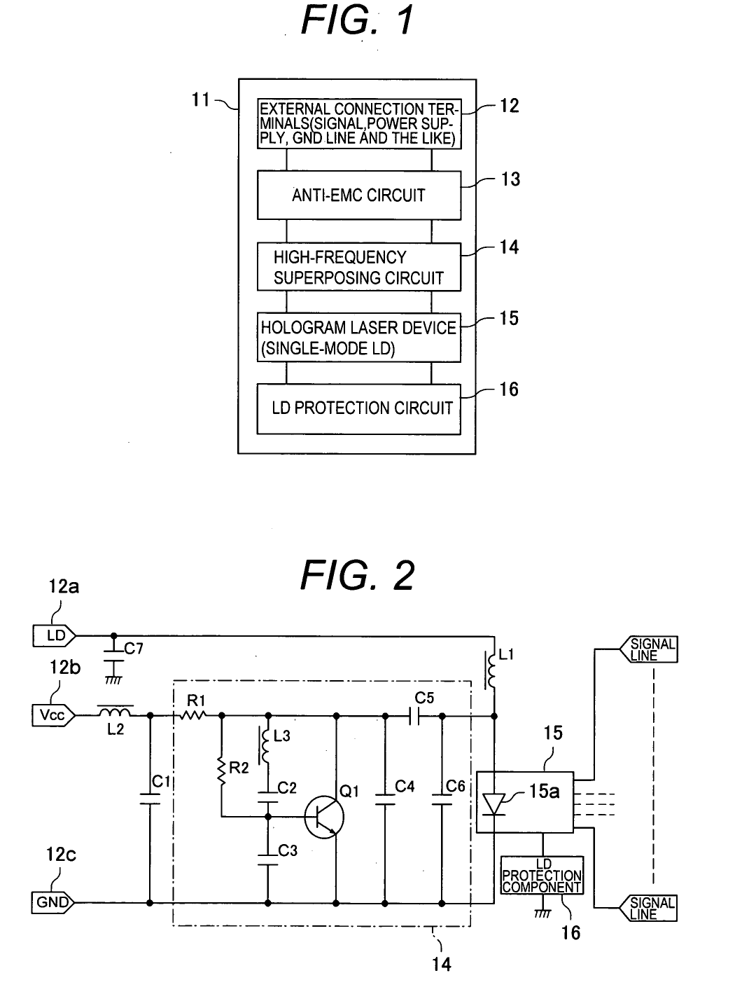

An ID module according to a first embodiment of the present invention will be described with reference to FIGS. 1 to 6T.

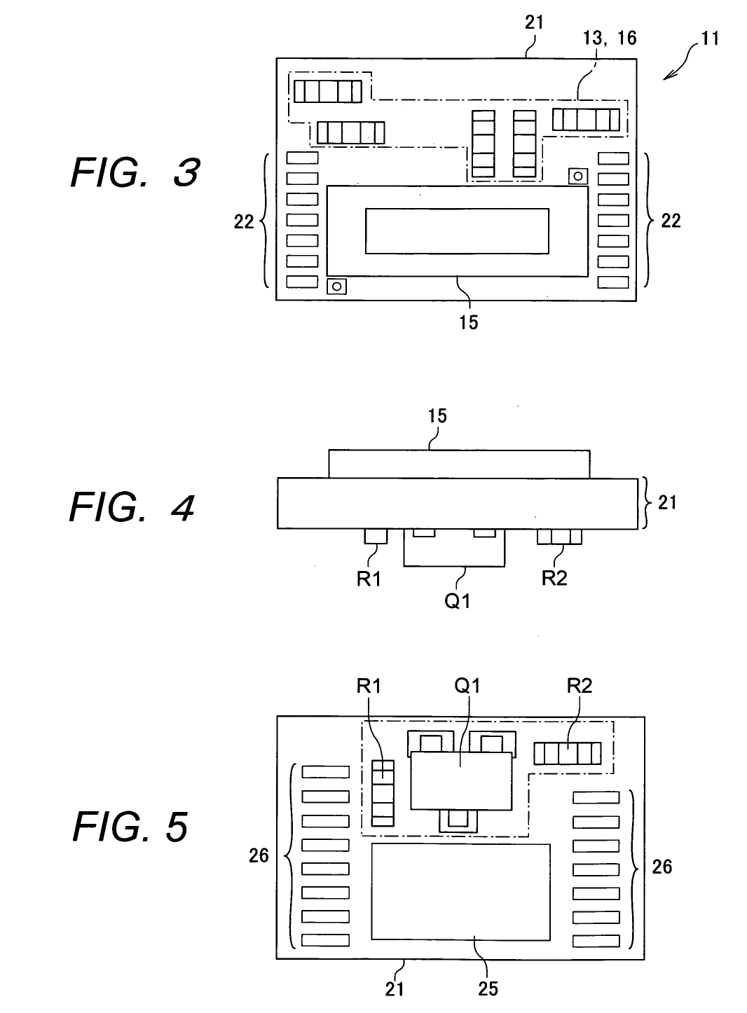

As illustrated in FIGS. 1 and 2, this LD module 11 comprises a hologram laser device 15 (light emitting/receiving unit component); a high frequency superposing circuit 14 for superposing a high frequency current on a driving current for an LD 15a included in the hologram laser device 15; an anti-EMC circuit 13 for reducing electromagnetic noise produced from the high frequency superposing circuit 14; and an LD protection circuit 16 for protecting the hologram laser device 15 (LD 15a) from electrostatic discharge damages (damages caused by electrostatic discharge (ESD)) and damages due to surge currents. These components 15, 14, 13, 16 are mounted on a multi-layer board (see FIG. 3 onward) for integration into a module. These components and circuit elements are mounted on the board (designated reference numeral 21 in FIG. 3 onward), which is implemented based on the present invention, for integration into the LD module 11.

The hologram laser device 15 comprises the single-mode LD 15a, a light receiving element (not shown), and a hologram element (not shown). Laser light emitted from the LD 15a reaches an optical disc through the hologram element. The laser light, which has reached the optical disc, is reflected thereby, and deflected by the hologram element to impinge on the light receiving element, so that information recorded on the disc is read.

The hologram laser device 15 is connected to signal lines through which recording/reproduced signals are applied/read to/from the hologram laser device 15; and the LD protection circuit (component) 16 for protecting the LD 15a from electrostatic discharge damages (damages due to electrostatic discharge (ESD)) and damages due to surge currents. The signal lines can be formed by a flexible printed circuit board (hereinafter called the “FPC”). The LD protection circuit (component) 16 used herein may be, for example, a varistor.

The LD module 11 also comprises a set of external connection terminals 12 which include a power input terminal 12b for supplying a driving current for the LD 15a, a ground terminal 12c, and an output terminal 12a coupled to a photo-detector (PD) for monitoring and controlling the output of the LD 15a.

The high frequency superposing circuit 14 is also connected to the hologram laser device 15, and the anti-EMC circuits 13 are interposed between the high frequency superposing circuit 14 and external connection terminal 12 (power input terminal 12b, ground terminal 12c) and between the external connection terminal 12 (output terminal 12a) and hologram laser device 15, respectively. The high frequency superposing circuit 14 includes an oscillator circuit and a matching circuit composed of a transistor Q1, a coil L3, capacitors C2-C6, resistors R1, R2. The anti-EMC circuit 13 is composed of a coil L2 connected between the power input terminal 12b and high frequency superposing circuit 14, a capacitor C1, and a coil L1 and a capacitor C7 connected between the output terminal 12a and hologram laser element 15. It should be noted that the capacitor C1 included in the anti-EMC circuit 13 also functions as a power stabilizing capacitance for permitting the oscillator circuit to stably operate.

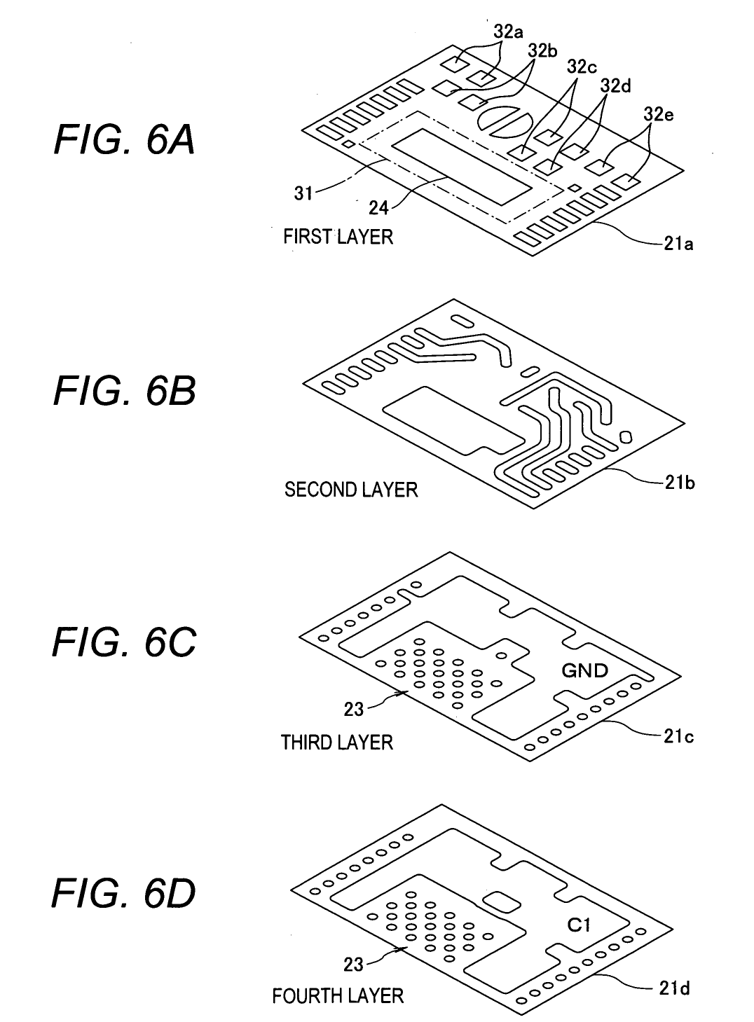

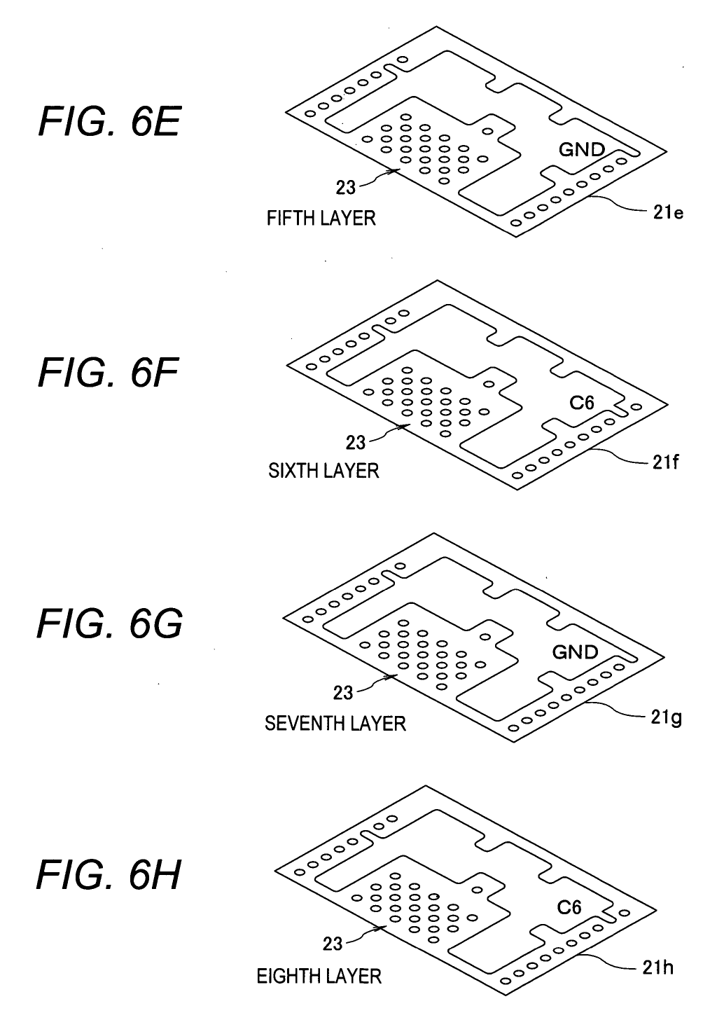

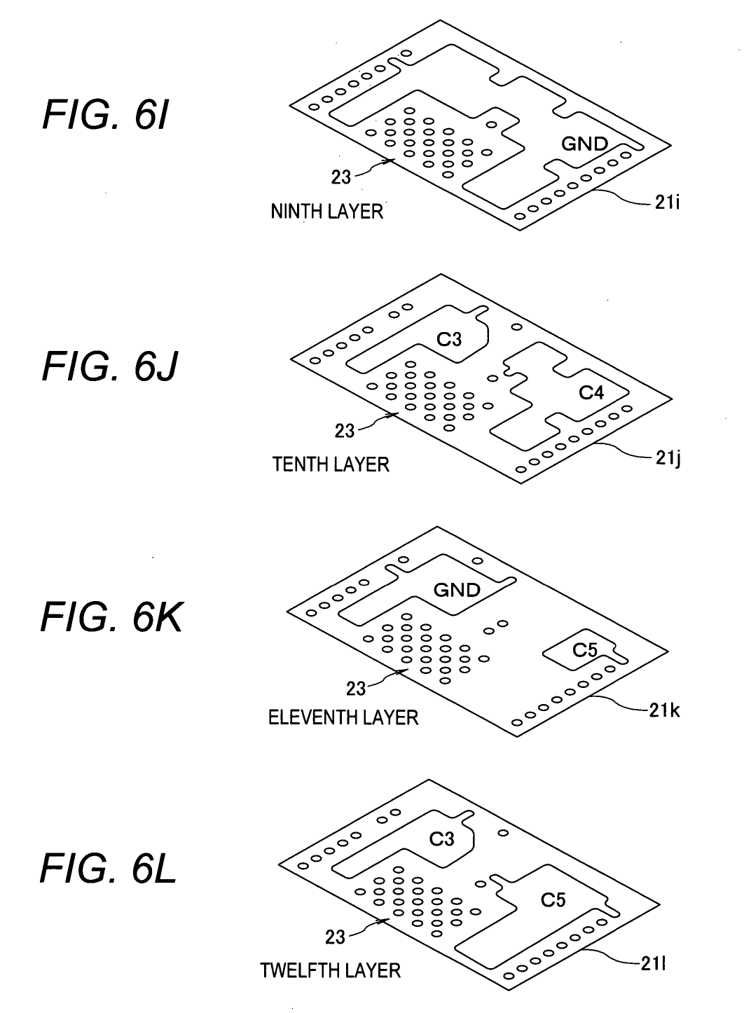

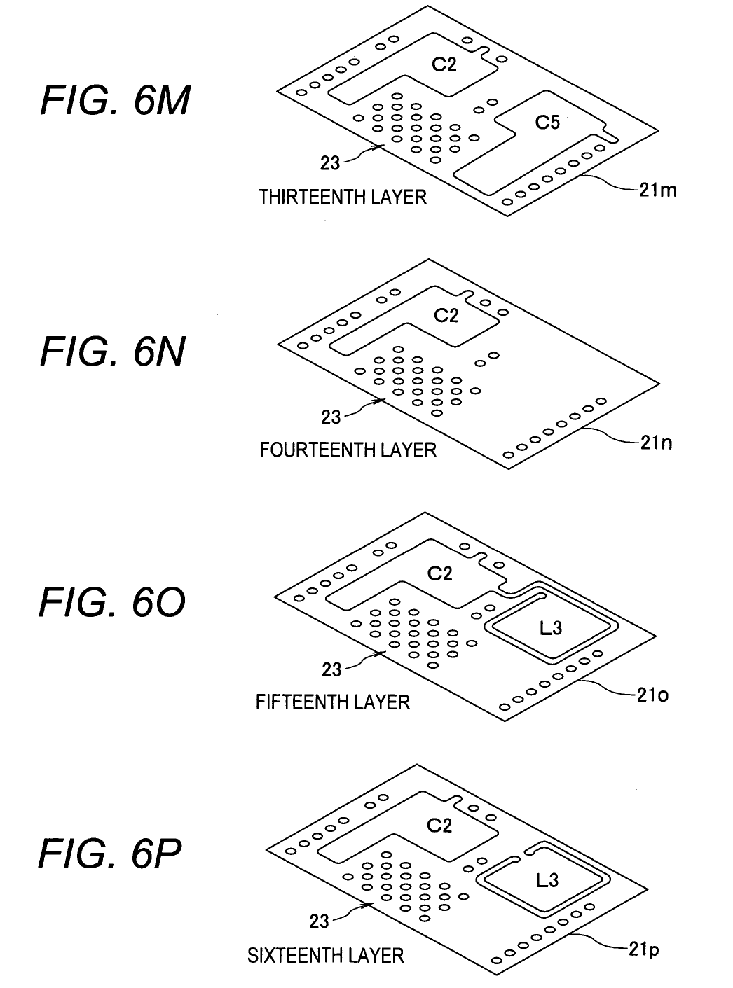

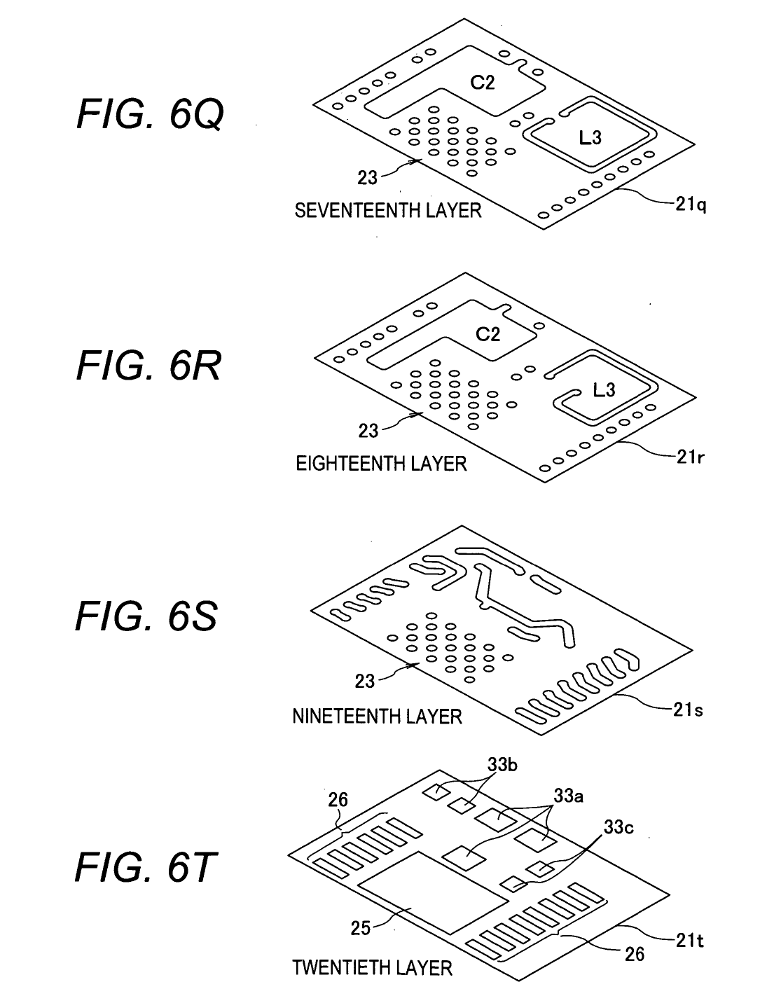

Among those passive elements which make up the high frequency superposing circuit 14 and anti-EMC circuit 13, the capacitors C1, C2, C3, C4, C5, C6 and coil L3 are built in the multi-layer board 21, as will be later described with reference to FIGS. 6A to 6T, while the capacitor C7 and coils L1, L2 are mounted on the surface of the multi-layer board 21 by using discrete parts.

FIGS. 3 to 5 illustrate outer appearances of the LD module 11, where FIG. 3 illustrates one surface (designated the top surface for convenience of description) of the multi-layer board 21; FIG. 4 illustrates a side surface of the multi-layer board 21; and FIG. 5 illustrates the other surface (designated the bottom surface for convenience of description) of the multi-layer board 21. As illustrated in these figures, the multi-layer board 21, which is substantially rectangular in shape, as viewed in plan view, has the hologram laser device 15, some of the passive elements which form part of the anti-EMC circuit 13, and LD protection circuit or component 16 which are surface mounted on the top surface thereof.

The hologram laser device 15 is positioned substantially at the center of the multi-layer board 21 in the longitudinal direction 21 thereof, and is formed with conductor patterns 22 formed in array on both end regions (therefore, both longitudinal end regions of the multi-layer board 21) for mounting the hologram laser device 15 by wire bonding (bonding wires are not shown. The same is applied to the following description). Also, a plurality of heat dissipation vias 23 are provided in a region of the multi-layer board 21 below the hologram laser device for dissipating heat produced from the ID 15a to the bottom surface of the multi-layer board 21 (see FIGS. 6C to 6S).

These heat dissipating vias 23 substantially vertically extend through the multi-layer board 21 straightly from a heat dissipating conductor pattern 24 formed on the top surface of the multi-layer board 21 in a mounting region of the hologram laser device 15 to reach a heat sink connection pattern 25 (later described) formed on the bottom surface of multi-layer board 21, and are connected to the heat sink connection pattern 25 so that heat can conduct thereto. The heat dissipating vias 23, as previously described, can be formed by filling, for example, plated throughholes with a conductive resin paste, or by filled vias through deposition of a plating metal in a column shape to fill the throughholes with the plating metal.

On the other hand, the multi-layer board 21 is surface mounted with the transistor Q1 and resistors R1, R2, which are included in the high frequency superposing circuit 14, on the bottom surface thereof. The heat sink connection pattern 25 is also formed substantially at the center of the multi-layer board 21 in the longitudinal direction in correspondence to the position at which the hologram laser device 15 is mounted. The aforementioned heat dissipating vias 23 are connected to the heat sink connection pattern 25, such that heat produced by the LD 15a is substantially straightly transferred to the bottom surface of the multi-layer board 21 through the shortest distance, and is efficiently dissipated to the outside through the heat sink connection pattern 25.

With respect to the longitudinal direction of the multi-layer board 21, conductor patterns 26 are formed in arrangement along the edges (shorter sides) of the board 21 on both sides (both end regions of the multi-layer board 21 in the longitudinal direction) of the heat sink connection pattern 25 (region in which heat dissipating vias 23 are formed) each for connecting a flexible printed circuit board (FPC). The patterns 26 thus arranged in the end regions of the board 21 can facilitate a connection of FPC's to the LD module 11. Terminals, which form part of the FPC connection patterns 26, are preferably the same or substantially the same in number on the left and right sides of the board 21 from a viewpoint of a reduction in size of the board 21.

FIGS. 6A to 6T are diagrams illustrating respective layers viewed from above, and in the following description, these layers are called a “first layer” to a “twentieth layer” from the top surface to the bottom surface of the board in order. FIG. 6T in turn illustrates a wiring layer within the board viewed from above, like FIGS. 6A to 6S, thus showing the lowermost layer (twentieth layer) of the board in a perspective form.

As illustrated in these figures, this multi-layer board is a low-temperature co-fired ceramics multi-layer board made up of twenty wiring layers, including the top and bottom surfaces of the board, wherein the first layer (top surface of the board) 21a is provided with a hologram laser device mounting area 31 around the center of the board 21 for mounting the hologram laser device 15 thereon. The hologram laser device mounting area 31 is formed with a conductor pattern 24 which is connected to the heat dissipating vias 23 that extend through the board 21 to the heat sink connection pattern 25 on the bottom surface of the board. Also, the first layer 21a is provided with connection pads 32a-32e for connecting the respective surface mount parts 13, 16 shown in FIG. 3. Among these connection pads, the connection pad 32e located at a corner of the board 21 is provided for mounting the coil L2 which forms part of the anti-EMC circuit 13.

On the other hand, the capacitor C1, which forms part of the anti-EMC circuit 13, is formed of a conductor pattern disposed on the fourth layer 21d and ground patterns disposed on the third layer 21C and the fifth layer 21e.

Here, the position at which the capacitor C1 is formed is chosen to be substantially beneath the coil L2 (connection pad 32e for the coil L2), which is surface mounted on the top surface (first layer) 21a of the board, and as close as possible to the position at which the coil L2 is mounted. If the anti-EMC circuit 13 includes the coil L2 and capacitor C1 spaced further apart from each other, parasitic reactance increases to degrade the characteristics of a filter formed of the coil L2 and capacitor C1. As the coil L2 is positioned closer to the capacitor C1 as in this embodiment, a shorter wire is required between the coil L2 and capacitor C1, thus making it possible to reduce the parasitic reactance, shift the resonance frequency of the filter to the higher side, and form a deeper notch of the filter to further reduce the noise.

It should be noted that the “position substantially beneath” used above (also in claims) means not only a position strictly vertically below (beneath) but also a position slightly shifted in the horizontal direction. This is because of the object of bringing the coil L2 closer to the capacitor C1 can be achieved. Also, from a similar reason, with respect to the vertical direction, the capacitor C1 is not necessarily formed on the immediately lower layer, but may be formed on a layer two or more layers away.

The capacitor C2, which forms part of the high frequency superposing circuit 14, is formed of conductor patterns disposed on the thirteenth layer 21m to the eighteenth layer 21r; and the capacitor C3 is formed of ground patterns disposed on the ninth layer 21i and eleventh layer 21k, and conductor patterns disposed on the tenth layer 21j and twelfth layer 21l, respectively. Likewise, the capacitor C4, included in the high frequency superposing circuit 14, is formed of the ground pattern on the ninth layer 21i and the conductor pattern on the tenth layer 21j; the capacitor C5 is formed of respective conductor patterns disposed on the tenth layer 21j to the thirteenth layer 21m; and the capacitor C6 is formed of conductor patterns and ground patterns disposed on the fifth layer 21e to the ninth layer 21i. Further, the coil L3, included in the high frequency superposing circuit 14, is formed of loop-shaped conductor patterns disposed on the fifteenth layer 21o to the eighteenth layer 21r.

The bottom layer (twentieth layer) 21t of the board is provided with connection pads 33a, 33b, 33c for surface mounting the transistor Q1 and resistors R1, R2, included in the high frequency superposing circuit 14, as well as the heat sink connection pattern 25 and FPC connection pattern 26.

The connection between the conductor patterns and connection pads on the respective layers can be made, for example, through plated throughholes. On the other hand, the FPC connection pattern 26, the connection pads 32, 33 for surface mount parts, and the respective conductor patterns such as those within the board can be formed, for example, by a thick film method which involves printing a conductive paste on the board, or by a thin film method such as sputtering.

The multi-layer board 21 may be, for example, a ceramic multi-layer board, or a low-temperature co-fired ceramics multi-layer board (LTCC board) using alumina and glass components in insulating layers, or an organic multi-layer board which employs a resin material for an insulating base material, or a composite material board made of a mixture of a resin material and an inorganic material.

In the aforementioned circuit of FIG. 2, a high-frequency superposed current is applied to the LD 15a from an oscillator circuit composed of Q1, C2, L3 and the like within the high frequency superposing circuit through matching elements C4-C6, and returns to the oscillator circuit through a return path (ground). Unwanted radiations are caused by a loop circuit, acting as an antenna, of the high frequency current which goes out from the oscillator circuit and returns thereto. How the unwanted radiations occur basically depends on the impedance and length of the loop circuit, and the unwanted radiations increase particularly in proportion to the length, though the wavelength is also related thereto. Also, high-frequency currents also leak from other lines connected to the LD 15a and high-frequency superposing circuit 14, leading to the occurrence of unwanted radiations. Further, generally used LD's are packaged, in which case wires (terminals and the like) of the package also act as antennas, thus exerting adverse effects on the unwanted radiations.

On the other hand, according to the module of the foregoing embodiment, the high-frequency superposing circuit 14 is mounted on the surface of the board or within the board, and the LD 15a, including peripheral parts, are directly mounted on the board for integration into a module, thus making it possible to reduce the length and shape of the loop circuit of the high-frequency current and paths along which high-frequency currents leak (i.e., portions acting as antennas). Consequently, the LD module of the first embodiment can reduce the unwanted radiations, eliminate the need for countermeasures against the radiations such as the provision of a shield case, and therefore reduce the size and cost of the optical pickup as well.

### Second Embodiment

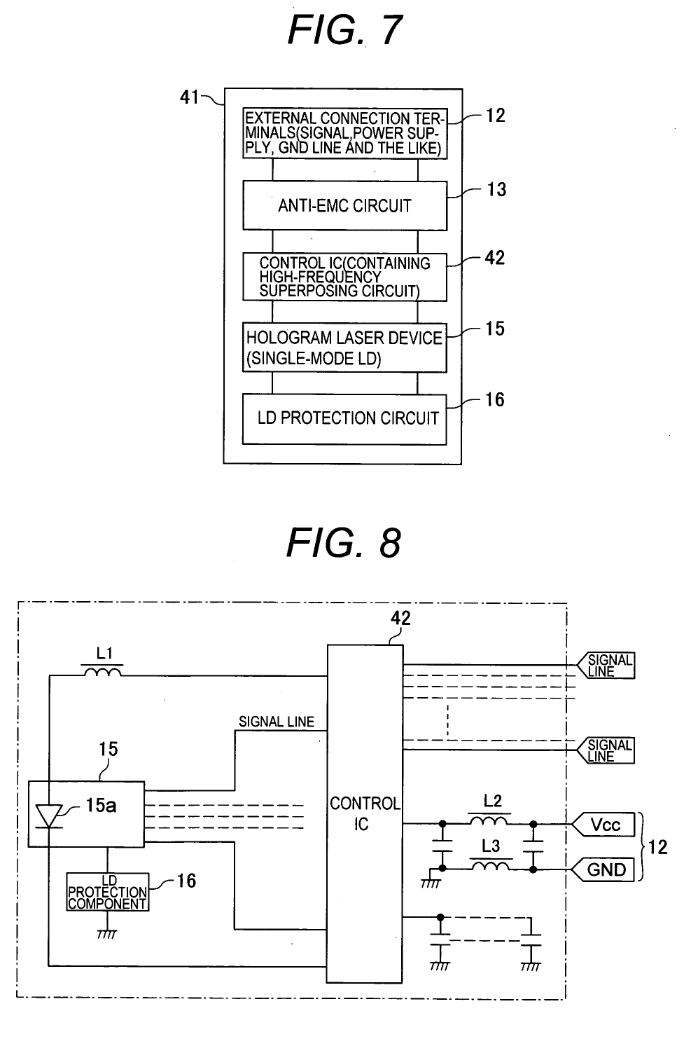

An LD module according to a second embodiment of the present invention will be described with reference to FIGS. 7 to 11.

As illustrated in FIGS. 7 and 8, this LD module 41 comprises a hologram laser device (light emitting/receiving unit component) 15, an LD protection circuit 16, and an anti-EMC circuit 13, similar to the module according to the first embodiment, but also comprises a control IC 42 mounted on a multi-layer board 45 for controlling recording/reproduced signals applied/read to/from the hologram laser device 15, for integration into a module. Also, a high-frequency superposing circuit is included in the control IC 42.

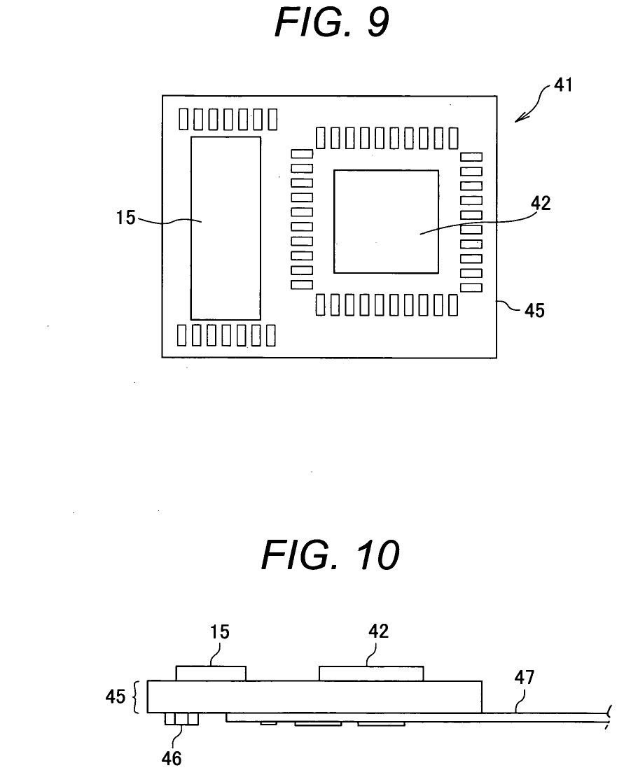

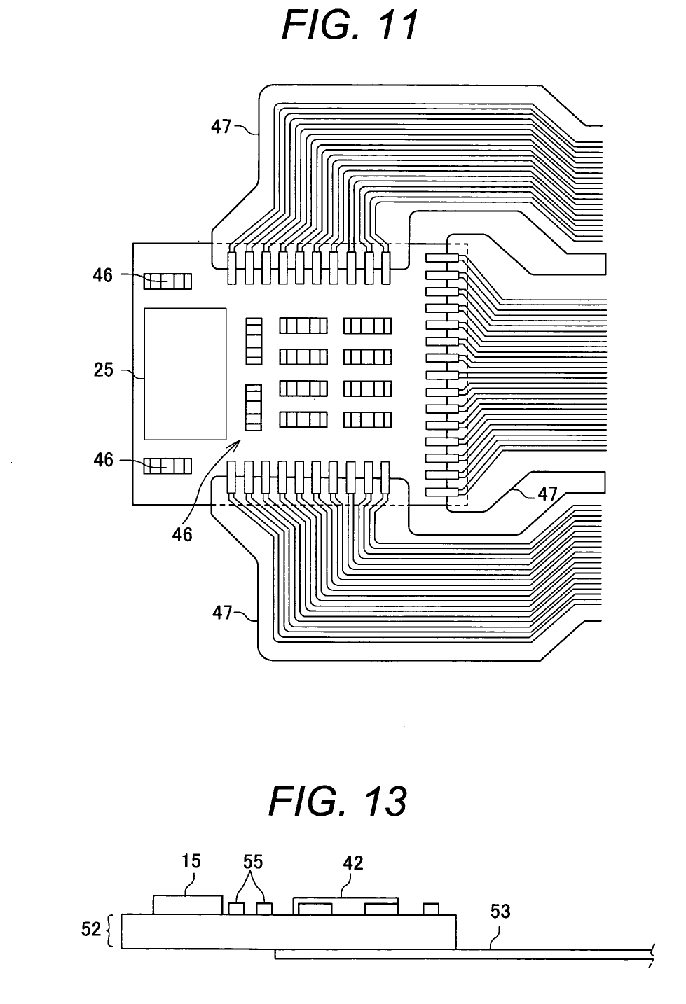

The hologram laser device 15 and control IC 42 are mounted on the top surface of the multi-layer board 45 by wire bonding, as illustrated in FIG. 9. Discrete parts which make up the LD protection circuit 16 and anti-EMC circuit 13, as indicated by reference numeral 46 in FIG. 11, and peripheral parts of the control IC 42 are surface mounted on the bottom surface of the multi-layer board 45. A heat sink connection pattern 25 is formed in one end region of the board 45 in alignment with the position at which the hologram laser device 15 is mounted on the top surface of the board. Also, an FPC connection pattern is formed along three sides of the board 45 in the remaining peripheral regions of the board except for the one end region in which the heat sink connection pattern 25 is formed, and an FPC 47 is connected to the connection pattern.

### Third Embodiment

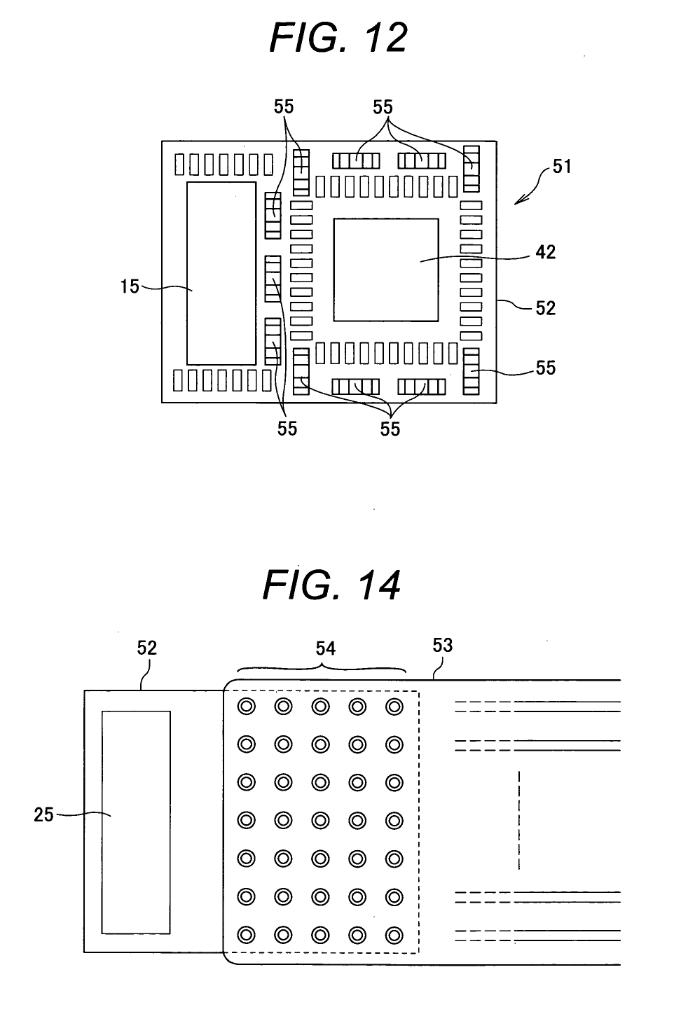

Further, an LD module according to a third embodiment of the present invention will be described with reference to FIGS. 12 to 14.

As illustrated in these figures, this module 51 integrally contains a hologram laser device 15, an LD protection circuit, an anti-EMC circuit, and a control IC 42 together with peripheral parts thereof within a module, similar to the module according to the second embodiment, but employs a double-sided FPC 53 as signal lines for connection to the module.

The hologram laser element 15 and control IC 42 are surface mounted on the top surface of a multi-layer board 52, as illustrated in FIG. 12, while peripheral parts of the IC 42, elements making up the LD protection circuit, and elements making up the anti-EMC circuit are also surface mounted on the top surface of the multi-layer board 52, as indicated by reference numeral 55 in FIG. 12, respectively. Also, some elements (for example, a capacitor) of the anti-EMC circuit are incorporated in the multi-layer board 52, in a manner similar to the first embodiment. On the other hand, an FPC connection pattern 54 for connecting the FPC 53 is formed on the bottom surface of the multi-layer board 52 in a matrix arrangement as illustrated in FIG. 14. Also, a heat sink connection pattern 25 is formed in an end region of the board on the side opposite to the other end region of the board in which the FPC connection pattern 54 is formed, in a manner similar to the module of the second embodiment.

### Fourth Embodiment

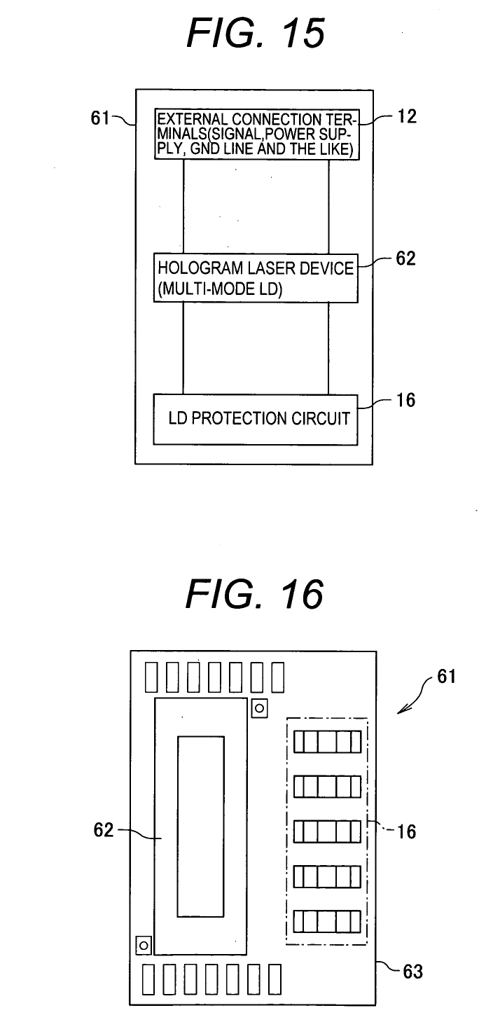

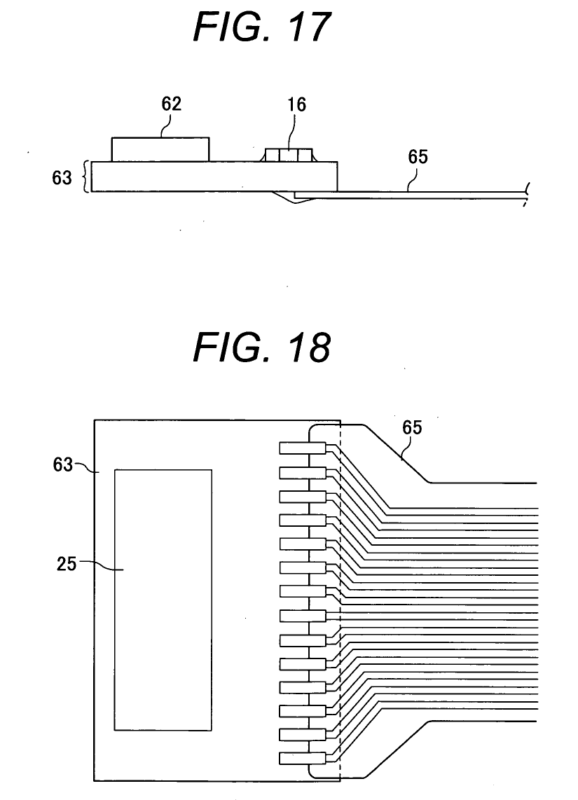

An LD module according to a fourth embodiment of the present invention will be described with reference to FIGS. 15 to 18.

As illustrated in FIG. 15, this module 61 comprises a hologram laser device 62 and an LD protection circuit 16 mounted on a multi-layer board 63 for integration into a module, in a manner similar to the module according to the first embodiment, but employs an LD (for example, a multi-mode LD) which does not require the high-frequency superposing circuit. Therefore, the module 61 does not comprise a high-frequency superposing circuit or an anti-EMC circuit.

As illustrated in FIG. 16, the hologram laser device 62 and LD protection circuit 16 are surface mounted on the top surface of the multi-layer board 63. A heat sink connection pattern 25 is formed on the bottom surface of the multi-layer board 63 in alignment to the position at which hologram laser 62 is mounted, at the same position on the back side. Also, a conductor pattern is formed in one edge region of the bottom surface of the board for connecting an FPC 65.

It should be further understood by those skilled in the art that the foregoing description has been made on embodiments of the invention and that various changes and modifications may be made in the invention without departing from the spirit of the invention and the scope of the appended claims.

What is claimed is:

1. A laser diode module multi-layer board comprising:
a light emitting/receiving unit mounting area for mounting thereon a light emitting/receiving unit component including a semiconductor laser diode for generating light irradiated to a storage medium, and a light receiving element for receiving reflected light from the storage medium; and
a laser diode protection component mounting area for mounting thereon a laser diode protection component for protecting said semiconductor laser diode from electric damages.

2. A laser diode module multi-layer board according to claim 1, wherein:
said board contains at least some of circuit elements of a high-frequency superposing circuit for superposing a high-frequency current on a current for driving said semiconductor laser diode, and at least some of circuit elements of an anti-EMC circuit for reducing electromagnetic noise produced from said high-frequency superposing circuit.

3. A laser diode module multi-layer board according to claim 2, further comprising a coil mounting area for mounting thereon a coil which forms part of said anti-EMC circuit, wherein:
said anti-EMC circuit comprises a capacitor incorporated in said board, and
said capacitor is arranged at a position substantially beneath said coil mounting area.

4. A laser diode module multi-layer board according to claim 1, further comprising a heat dissipating via hole extending through said laser diode module multi-layer board and formed in an area in which said light emitting/receiving unit component is mounted, for dissipating heat produced from said semiconductor laser diode to the opposite surface side of said board to the board surface on which said light emitting/receiving unit mounting area is defined.

5. A laser diode module multi-layer board according to claim 1, further comprising a connection pattern for a flexible printed circuit board, wherein:
said light emitting/receiving unit mounting area is defined on one surface of said laser diode module multi-layer board, and
said connection pattern for a flexible printed circuit board is defined on the other surface of said laser diode module multi-layer board.

6. A laser diode module multi-layer board according to claim 5, wherein said connection pattern for a flexible printed circuit board is formed in arrangement along an edge of said laser diode module multi-layer board.

7. A laser diode module multi-layer board according to claim 6, further comprising a heat dissipating via hole extending through said laser diode module multi-layer board and formed in an area in which said light emitting/receiving unit component is mounted, for dissipating heat produced from said semiconductor laser diode to the opposite surface side of said board to the board surface on which said light emitting/receiving unit mounting area is defined,
wherein said connection pattern for a flexible printed circuit board is disposed on each of both sides of the area in which said heat dissipation via hole is formed.

8. A laser diode module multi-layer board according to claim 1, further comprising an active element mounting area for mounting thereon a semiconductor active element which forms part of a high-frequency superposing circuit for superposing a high-frequency current on a current for driving said semiconductor laser diode, wherein:
said light emitting/receiving unit mounting area is defined on one surface of said laser diode module multi-layer board, and
said active element mounting area is defined on the other surface of said laser diode module multi-layer board.

9. A laser diode module multi-layer board according to claim 8, further comprising a reference potential layer disposed between said light emitting/receiving unit mounting area and said active element mounting area.

10. A laser diode module multi-layer board according to claim 9, wherein said board comprises two or more of said reference potential layers.

11. A laser diode module comprising:
a light emitting/receiving unit component including a semiconductor laser diode for generating light irradiated to a storage medium, and a light receiving element for receiving light reflected from the storage medium; and
a laser diode protection component for protecting said semiconductor laser diode from electric damages,
said light emitting/receiving unit component and said laser diode protection component being integrated in a single module.

12. A laser diode module according to claim 11, wherein:
said semiconductor laser diode is a single-mode semiconductor laser diode, and
said module further comprises a high-frequency superposing circuit integrated therein for superposing a high-frequency current on a current for driving said single-mode semiconductor laser diode.

13. A laser diode module according to claim 12, further comprising an anti-EMC circuit integrated therein for reducing electromagnetic noise produced from said high-frequency superposing circuit.

14. A laser diode module according to claim 13, wherein:
said light emitting/receiving unit component is mounted on a surface of a multi-layer board, and
at least one of circuit elements making up one or both of said high frequency superposing circuit and said anti-EMC circuit are incorporated in said multi-layer board.

15. A laser diode module according to claim 13, wherein:
said light emitting/receiving unit component is mounted on a surface of a multi-layer board,
said anti-EMC circuit includes a coil and a capacitor,
said coil is mounted on the surface of said multi-layer board, and
said capacitor is incorporated in said multi-layer board and arranged at a position substantially beneath said coil.

16. A laser diode module according to claim 14, wherein:
said laser diode module multi-layer board includes a heat dissipating via hole extending therethrough and formed in an area in which said light emitting/receiving unit component is mounted, for dissipating heat produced from said semiconductor laser diode to the opposite surface side of said board to the board surface on which said light emitting/receiving unit component is mounted.

17. A laser diode module according to claim 14, further comprising a connection pattern for a flexible printed circuit board, wherein:
said light emitting/receiving unit component is mounted on one surface of said multi-layer board, and
said connection pattern for a flexible printed circuit board is disposed on the other surface of said multi-layer board.

18. A laser diode module according to claim 17, wherein:
said connection pattern for a flexible printed circuit board is formed in arrangement along an edge of said multi-layer board.

19. A laser diode module according to claim 18, wherein:
said laser diode module multi-layer board includes a heat dissipating via hole extending therethrough and formed in an area in which said light emitting/receiving unit component is mounted, for dissipating heat produced from said semiconductor laser diode to the opposite surface side of said board to the board surface on which said light emitting/receiving unit component is mounted, and
said connection pattern for a flexible printed circuit board is arranged on each of both sides of the area in which said heat dissipation via hole is formed.

20. A laser diode module according to claim 14, wherein:
said semiconductor laser diode is a single-mode semiconductor laser diode,
said module further comprises a high-frequency superposing circuit integrated therein for superposing a high-frequency current on a current for driving said single-mode semiconductor laser diode,
said light emitting/receiving unit component is mounted on one surface of said multi-layer board, and
a semiconductor active element included in said high-frequency superposing circuit is mounted on the other surface of said multi-layer board.

21. A laser diode module according to claim 20, further comprising a reference potential layer disposed between said light emitting/receiving unit component and said semiconductor active element.

22. A laser diode module according to claim 21, wherein:
said module comprises two or more of said reference potential layers.

23. A laser diode module according to claim 11, further comprising an IC, integrated therein, capable of controlling a reproduced signal outputted from said light emitting/receiving unit component, or a reproduced signal and a recording signal outputted/inputted to/from said light emitting/receiving unit component.
